(19) United States
(12) Patent Application Publication
(10) Pub. No.: US 2009/0075127 A1
(43) Pub. Date: Mar. 19, 2009

(54) METHOD FOR MEASURING HIGH-FREQUENCY RESISTANCE OF FUEL CELL IN A VEHICLE

(75) Inventors: Sebastian Lienkamp, Budenheim (DE); Peter Willimowski, Rossdorf (DE); Bernd Peter Elgas, Hilbersheim (DE)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/856,122

(22) Filed: Sep. 17, 2007

(51) Int. Cl. H01M 8/04

(52) U.S. Cl. 429/13; 429/12

(57) ABSTRACT

A transient load can be applied to a fuel cell stack to generate an AC voltage across and an AC current through the fuel cell stack. The AC voltage and AC current can be used to ascertain an impedance of the fuel cell stack. The ascertained impedance can be correlated to a state of hydration of the fuel cell stack thereby providing an independent determination of the state of hydration. The independently determined state of hydration can be used as a diagnostic tool to verify a different independent determination of the state of hydration and/or as an input for controlling operation of the fuel cell stack.

### FIELD

The present teachings relate to fuel cell operation and, more particularly, to apparatus and methods for ascertaining and/or verifying a relative humidity or state of hydration of a fuel cell and/or fuel cell stack using a measure of high-frequency resistance.

### BACKGROUND AND SUMMARY

The statements in this section merely provide background information related to the present teachings and may not constitute prior art.

Fuel cells are used as a power source for electric vehicles, stationary power supplies, and other applications. One known fuel cell is the PEM (i.e., Protonic Exchange Membrane) fuel cell that includes a so-called MEA (“Membrane-Electro-Assembly”) comprising a thin, solid polymer membrane-electrolyte having an anode on one face and a cathode on the opposite face. The MEA is sandwiched between a pair of electrically conductive contact elements which serve as current collectors for the anode and cathode, which may contain appropriate channels and openings therein for distributing the fuel cells gaseous reactants (i.e., H₂ and O₂/air) over the surfaces of the respective anode and cathode.

A plurality of PEM fuel cells can be stacked together with the MEAs in electrical series while being separated one from the next by an impermeable, electrically conductive contact element known as a bipolar plate or current collector to thereby form a fuel cell stack or assembly. In some types of fuel cell stacks, each bipolar plate is comprised of two separate plates that are attached together with a fluid passageway therebetween through which a coolant flows to remove heat from both sides of the MEAs. In other types of fuel cell stacks, the bipolar plates include both single plates and attached-together plates which are arranged in a repeating pattern with at least one surface of each MEA being cooled by a coolant fluid flowing through the two bipolar plates.

The fuel cell stack is operated in a manner than maintains the MEAs in a humidified state. The level of humidity of the MEAs affects the performance of the fuel cells. Additionally, if an MEA is run too dry, the MEA can be damaged, which can cause immediate failure or reduce the useful life of the associated fuel cell and/or fuel cell stack.

In some instances, the load demand placed on the fuel cell stack can be highly dynamic. For example, in a vehicle employing a fuel cell stack, the load demand can vary greatly to meet a driver's torque request. During dynamic operation of the fuel cell stack, the relatively humidity requirements for the gas flow into the fuel cell cathodes and out of the fuel cell cathodes are attempted to be followed as precisely and often as possible to ensure performance and durability of the fuel cell stack. To this end, fuel cell stacks typically include a number of sensors within the system that are used to ascertain the state of hydration (SOH) of the fuel cell stack. These sensors and the ascertained SOH can be used to alter/adjust the relative humidity of the gas flows into and out of the fuel cell stack to match the operational requirements for the demand placed on the fuel cell stack.

It would be advantageous to be able to ascertain the accuracy or effectiveness of the sensors and the associated SOH determination. It would further be advantageous if such ability functioned independently of the sensors and the calculations used to determine the SOH. Furthermore, it would be advantageous if such a system were of low cost and required few extra components to implement.

The high-frequency resistance (HFR) of a fuel cell closely relates to the ohmic resistance (impedance) of the membrane which itself is a function of its degree of humidification. According to the present teachings, a measure of the HFR may be used as a relative humidity (SOH) control diagnostic. The HFR measurement result can show the extent to which the fuel cell membranes are hydrated (SOH). The HFR measurement may provide an independent diagnostic functionality which can ensure proper RH control over the life of the fuel cell stack. The independent diagnostic functionality may be able to identify changes in system behavior, sensor drift, and other factors that influence the ability of the sensors to ascertain the SOH of the fuel cell stack.

According to the present teachings, a transient load can be applied to a fuel cell stack to generate an AC voltage across and an AC current through the fuel cell stack. The AC voltage and AC current can be used to ascertain an impedance of the fuel cell stack. The ascertained impedance can be correlated to a state of hydration of the fuel cell stack thereby providing an independent determination of the state of hydration. The independently determined state of hydration can be used as a diagnostic tool to verify a different independent determination of the state of hydration and/or as an input for controlling operation of the fuel cell stack.

Further areas of applicability will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a schematic representation of an exemplary fuel cell system in which the control strategy of the present teachings can be utilized;

FIG. 2 is a schematic representation of a portion of the fuel cell system of FIG. 1 with an exemplary mechanization to implement the control strategy according to the present teachings;

FIGS. 3A and 3B are schematic representations of exemplary signal conditioning modules that can be used with the mechanization of FIG. 2;

FIG. 4 is a flowchart illustrating the determination of the high-frequency resistance according to the present teachings; and

FIG. 5 is a flowchart illustrating the control strategy of the present teachings.

### DETAILED DESCRIPTION

The following description is merely exemplary in nature and is no way intended to limit the present teachings, applications, or uses.

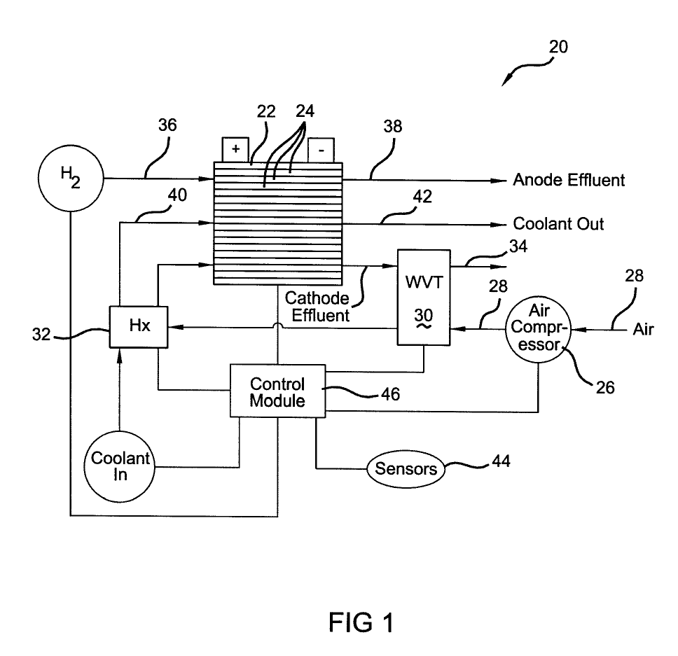

An exemplary fuel cell system 20, in which the control strategy according to the present teachings can be used, is illustrated in FIG. 1. Fuel cell system 20 can be a stationary fuel cell system or can be a mobile fuel cell system, such as when employed on a mobile platform (e.g., bus, automotive vehicle, and the like). Fuel cell system 20 includes a fuel cell stack 22 which can include a plurality of fuel cells 24 arranged adjacent one another to form stack 22. Fuel cell stack 24 includes a cathode flow path and an anode flow path that allow a cathode reactant and an anode reactant to flow therethrough for reaction therein to produce electricity.

Cathode reactant, in this case in the form of air, may be supplied to the cathode flow field of fuel cell stack 22 via a compressor 26 and cathode supply plumbing 28. Alternatively, the cathode reactant can be supplied from a pressurized storage tank (not shown). The cathode reactant gas may flow from compressor 26 through a humidifying device 30, in this case in the form of a water vapor transfer (WVT) device, wherein the cathode reactant gas is humidified to achieve a desired relative humidity (RH) or state of hydration (SOH) of fuel cell stack 22. The cathode reactant gas may flow through an optional heat exchanger 32, wherein the cathode reactant gas can be heated or cooled, as needed, prior to entering fuel cell stack 22.

The cathode reactant gas flows through the cathode reactant flow fields (cathode flow path) of fuel cell stack 22 and exits fuel cell stack 22 in the form of cathode effluent via cathode exhaust plumbing 34. The cathode effluent may be routed through WVT device 30.

Within WVT device 30, humidity from the cathode effluent stream may be transferred to the cathode reactant gas being supplied to fuel cell stack 22. The operation of WVT device 30 may be adjusted to provide differing levels of water vapor transfer between the cathode effluent stream and the cathode reactant stream.

Anode reactant, in this case in the form of H₂, is supplied to the anode flow fields (anode flow path) of fuel cell stack 22 via anode supply plumbing 36. Anode reactant gas may be supplied from a storage tank, a methanol or gasoline reformer, or the like. The anode reactant flows through the anode reactant flow path and exits fuel cell stack 22 in the form of anode effluent via anode exhaust plumbing 38.

Coolant may be supplied to a coolant flow path within fuel cell stack 22 via coolant supply plumbing 40 and is removed from fuel cell stack 22 via coolant exit plumbing 42. The coolant flowing through fuel cell stack 22 removes heat generated therein by the reaction between the anode and cathode reactants. The coolant can also control the temperature of the cathode reactant and/or cathode effluent as it travels throughout the cathode reactant flow path within fuel cell stack 22. Optionally, the coolant may flow through heat exchanger 32 prior to entering fuel cell stack 22, thereby equalizing the temperature of the cathode reactant gas and the coolant prior to entering fuel cell stack 22. In this manner, the temperature of the cathode reactant flowing into the fuel cell stack 22 can be controlled to a desired set point.

Fuel cell system 20 includes a plurality of sensors 44 that can provide signals indicative of various operating conditions or parameters of fuel cell system 20. For example, sensors 44 can include temperature sensors, pressure sensors, flow rate sensors, relative humidity sensors, and the like, by way of non-limiting example.

A control module 46 communicates with the various components of fuel cell system 20 to control and coordinate their operation and meet the load demand placed on fuel cell stack 22. As used herein, the term “module” refers to an application-specific integrated circuit (ASIC), an electronic circuit, a processor (shared, dedicated, or group) and memory that execute one or more software or firmware programs, a combinational logic circuit, or other suitable components that provide the desired functionality. Control module 46 can be a single integrated control module or can include a plurality of modules whose actions are coordinated to provide a desired overall operation of fuel cell system 20.

Control module 46 communicates with the various components of fuel cell system 20 to control and coordinate their operation. For example, control module 46 communicates with compressor 26 to control the stoichiometric quantity of cathode reactant supplied to fuel cell stack 22. Control module 46 also communicates with WVT device 30 to control the humidification of the cathode reactant flowing into fuel cell stack 22. Control module 46 communicates with heat exchanger 32 to control the temperature of the cathode reactant flowing into fuel cell stack 22. Control module 46 also communicates with the coolant supply system to control the flow rate of coolant through fuel cell stack 22 and also the temperature of the coolant routed through fuel cell stack 22. Control module 46 also communicates with the anode reactant supply system to control the quantity of anode reactant supplied to fuel cell stack 22 to meet the varying demand loads placed on fuel cell stack 22. Control module 46 also communicates with sensors 44 to ascertain the operational state of fuel cell system 20 and perform the necessary functions to meet the demand load placed on fuel cell stack 22.

The desired operating conditions of fuel cell stack 22 and fuel cell system 20 are typically defined in terms of intervals of process conditions, such as pressure, temperature, stoichiometry, and relative humidity within the stack. The resulting multi-variable space (operating condition space or OCS) defines the steady-state normal operating boundary that results in best performance and durability of fuel cell stack 22. Transient operation may result in stack conditions outside the OCS, resulting in drying or wetting of the stack, the membrane, and the soft goods.

Excursions outside the OCS boundary are expected to happen in a real system due to dynamic limitations of components in following the load profile in a typical drive cycle. To address this, the control module 46 typically utilizes a control strategy that monitors the SOH of fuel cell stack 22 and manages the desired set point for the stack relative humidity to maintain the SOH of fuel cell stack 22 within an optimal range. To accomplish this, control module 46 relies upon input signals from sensors 44 to ascertain the SOH and to implement the appropriate operational changes to maintain the SOH of fuel cell stack 22 in the desired or optimal range.

Over time, changes in the behavior of fuel cell system 20 can occur. Additionally, drift of sensors 44 can also occur. These changes in fuel cell system 20 behavior and the sensor drift may result in the SOH determination of fuel cell stack 22 being in error or less precise. To account for this possibility, the present teachings disclose an independent method of verifying the SOH determination of control module 46. This independent control diagnostic utilizes the relationship between the high-frequency resistance (HFR) of the membranes of fuel cell stack 22 and the degree of humidification (SOH). The HFR of fuel cell stack 22 closely relates to the ohmic resistance (impedance) of the membranes in fuel cell stack 22 which itself is a function of its degree of humidification (SOH). An independent ability to ascertain the HFR of fuel cell stack 22 can be utilized as a control diagnostic tool to verify the SOH determination of control module 46 utilizing sensors 44. The independent diagnostic functionality can ensure proper RH control of fuel cell stack 22 over its lifetime.

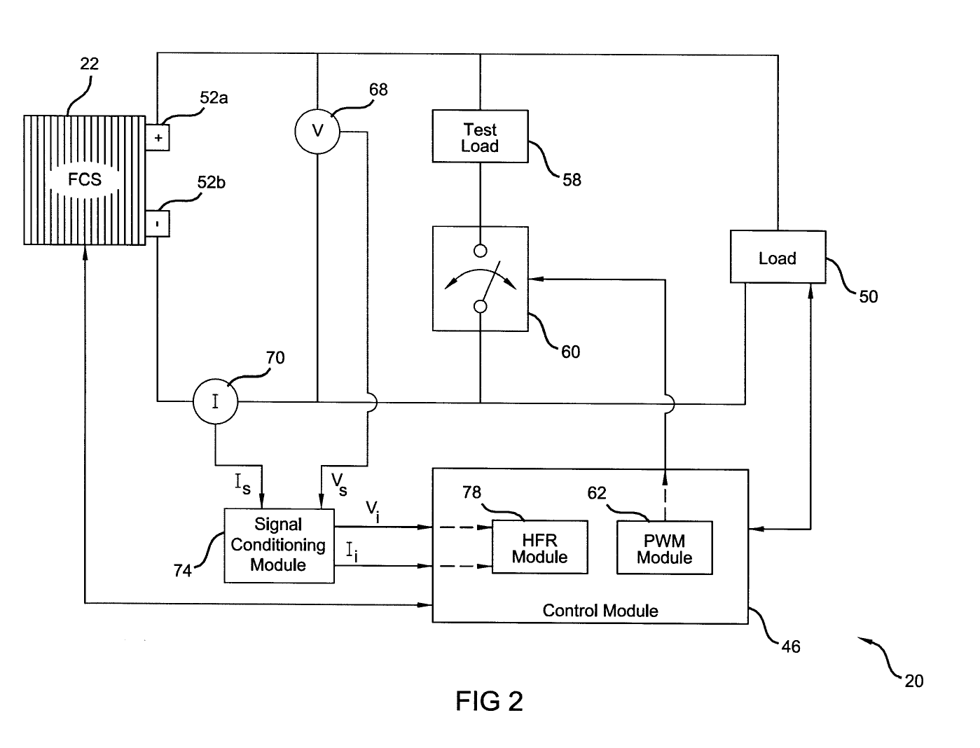

Referring to FIG. 2, an exemplary mechanization that enables the independent determination of the HFR and the associated SOH of fuel cell stack 22 is shown integrated into fuel cell system 20. Fuel cell stack 22 is operated by control module 46 to produce a DC voltage and DC current to meet the demand of a load 50 placed thereon across terminals 52a, 52b. The demand of load 50 may vary and operation of fuel cell stack 22 is adjusted by control module 46 to meet that demand. To provide an independent method of determining the HFR of fuel cell stack 22, a test load 58 can be selectively applied across terminals 52a, 52b in parallel with load 50. By selectively applying test load 58 to terminals 52a, 52b, an AC current can be induced. The induced AC current can cause the voltage of fuel cell stack 22 to be modulated by the AC current thereby inducing an AC voltage. A switching device 60 can be placed in series with test load 58 to selectively apply test load 58 to terminals 52A, 52B. Switch 60 is schematically illustrated in FIG. 2. It should be appreciated that switch 60 can take a variety of forms. For example, switch 60 can be an electronic switch such as an insulated gate bipolar transistor (IGBT).

A variety of components can be utilized as test load 58. Preferably, test load 58 has a minimal or diminimis affect on the operation of fuel cell system 20 and its ability to meet the demand of load 50. Additionally, it is preferred that test load 58 can be switched on and off at a frequency that can facilitate the ascertation of the induced AC voltage and AC current. One example of a suitable test load 58 includes an electrical heater. The electrical heater can be switched on and off with switch 60 to induce a small AC current and AC voltage in fuel cell system 20. The amplitude of the induced AC current and AC voltage by the electrical heater can be very small relative to the nominal DC current and DC voltage of fuel cell system 20. The use of a heater provides an ohmic load that can be switched on and off at a specific frequency. The heat generated by test load 58, when in the form of a heater, may be limited and/or minimized by executing the HFR measurement as a short check repeated in intervals rather than doing it continuously. It should be appreciated, however, that continuous operation of test load 58 to ascertain the HFR of fuel cell stack 22 can be employed, if desired. Another example of a suitable test load 58 includes an inverter or compressor utilized in fuel cell system 20. The inverter or compressor could be changed in order to generate a current oscillation of a desired frequency. The induced current oscillation will result in the voltage of fuel cell stack 22 being modulated by the AC current oscillation and produce an AC voltage. Moreover, the use of a heater and inverters as test load 58 can be advantageous in that these components may already be present in fuel cell system 20 and, thus, would not be new or additional hardware.

Switch 60 is operable to selectively place test load 58 across terminals 52a, 52b of fuel cell stack 22. Switch 60 can be controlled by a pulse width modulation (PWM) module 62. PWM module 62 can be integral with control module 46. PWM module 62 cycles switch 60 on and off at a desired frequency to apply test load 58 across terminals 52a, 52b of fuel cell stack 22 at that desired frequency. The frequency with which switch 60 is commanded to turn on and off results in test load 58 inducing an AC current and AC voltage oscillation of fuel cell stack 22 at that frequency. As a result, fuel cell stack 22 will produce a DC voltage and a DC current along with an AC voltage ripple and an AC current ripple at that frequency. The AC current and voltage can be utilized to ascertain the HFR of fuel cells 24.

The frequency at which PWM module 62 applies test load 58 across terminals 52a, 52b of fuel cell stack 22 may be chosen to avoid the impedance caused by components of fuel cell system 20. For example, components of fuel cell system having capacitance attributes may show up in the lower frequencies. Similarly, components having conductive attributes may show up in higher frequencies. PWM module 62 can apply test load 58 at a frequency or in a range of frequencies that avoid the capacitive portions and the conductive portions. In that operating window, the capacitive and conductive portions may be excluded or inconsequential and the induced current and voltage caused by test load 58 can be more easily ascertained. The specific frequency(s) with which PWM module 62 drives test load 58 can vary based on the components of fuel cell system 20. For example, the types and number of inverters utilized in fuel cell system 20 can affect the frequencies at which the capacitive portions can show up. Additionally, the properties of the wiring of fuel cell system 20 can affect the frequency at which the conductive portions show up. Thus, the specific frequencies may vary based upon the design and components of fuel cell system 20. For example, PWM module 62 can command switch 60 to turn and off at a frequency between about 1 khz and about 10 khz by way of non-limiting example.

Along with avoiding the capacitive and conductive portions that can show up in measuring the impedance, the particular properties of test load 58 can also affect the frequency at which PWM module 62 drives test load 58. In particular, the ability of test load 58 to be switched on and off can affect the frequency at which it is driven by PWM 62.

An output of a voltage sensor 68 and a current sensor 70 are supplied to a signal conditioning module 74. Voltage sensor 68 measures the stack voltage (Vₛ) which includes both the DC voltage and the AC voltage produced by fuel cell stack 22 and supplies a signal indicative of these voltages to signal conditioning module 74. Similarly, current sensor 70 measures the stack current (Iₛ) which includes both the DC current and the AC current flowing through fuel cell stack 22 and supplies a signal indicative of these currents to conditioning module 74.

Signal conditioning module 74 is operable to extract the induced AC voltage and AC current from the voltage and current signals provided by voltage sensor 68 and current sensor 70 and supply signals Vᵢ, Iᵢ indicative of the induced AC voltage and current to HFR module 78. HFR module 78 is operable to calculate the high-frequency resistance or impedance of fuel cells 24 and/or fuel cell stack 22, utilizing the signals provided by signal conditioning module 74, as described below.

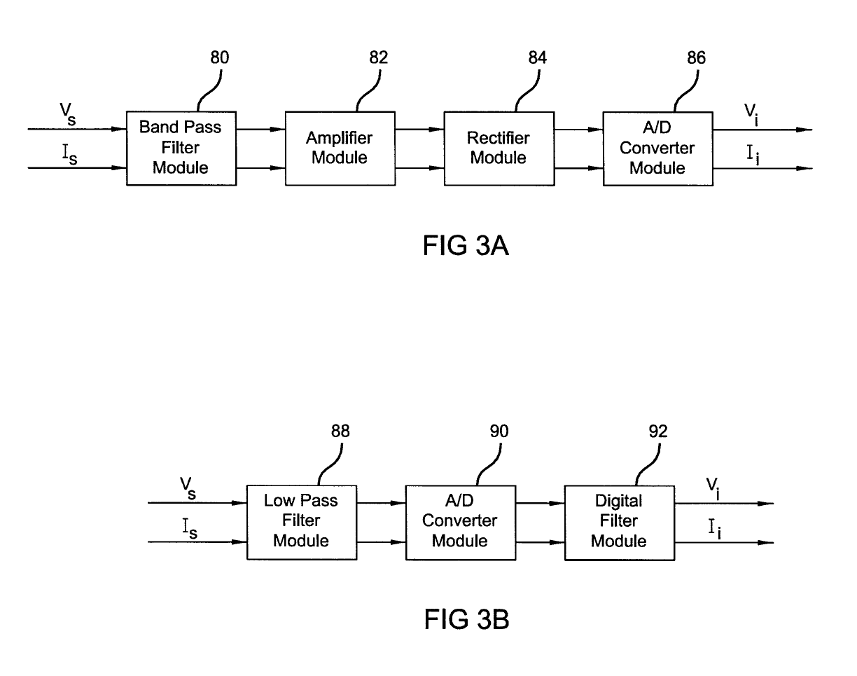

Signal conditioning module 74 can include one or more modules therein to extract the induced AC voltage and AC current and supply signals Vᵢ, Iᵢ to HFR module 78. In one example, as shown in FIG. 3A, signal conditioning module 74 may include a band pass filter module 80, an amplifier module 82, a rectifier module 84, and an analog-to-digital converter module 86. Filter module 80 is operable to allow voltage and current signals within a predetermined frequency range to pass therethrough while blocking voltage and current signals below and above the frequency range. Band pass filter module 80 may match the frequency at which switch 60 is driven by PWM module 62. The specific frequencies that signal conditioning module 80 allows to pass therethrough will vary based upon the type of test load 58 utilized and the frequency at which test load 58 is coupled across terminals 52a, 52b of fuel cell stack 22.

The band pass capability of signal conditioning module 74 will filter out lower and higher frequencies while keeping the signals corresponding to a desired frequency range. The filtering out of high-frequency signals can reduce and/or eliminate the induced current and voltage caused by components of fuel cell system 20, such as power inverters, DC/DC converters, and the like, by way of non-limiting example and also eliminate conductive portions of fuel cell system 20, such as that caused by the wires used in fuel cell system 20. The lower frequency can be chosen to eliminate the low frequency current and voltage components induced by other components of fuel cell system 20 along with removing the capacitive portion. The band pass filter module 80 can include analog devices, such as discreet electronic components that may include capacitors, resistors, etc.

The voltage and current signals allowed to pass through band pass filter module 80 may be supplied to amplifier module 82. Amplifier module 82 can amplify the induced voltage Vᵢ and induced current Iᵢ signals. The induced AC current and voltage signals may be very small relative to the DC current and voltage signals. As such, the use of amplifier module 82 can advantageously facilitate the handling and processing of the induced voltage and current signals. Additionally, the use of amplifier module 82 may allow the use of a lower resolution A/D converter module, thereby saving costs.

The amplified induced voltage and current signals may go from amplifier module 82 to rectifier module 84. Rectifier module 84 may convert the induced AC current Iᵢ and induced AC voltage Vᵢ that pass through band pass filter module 80 and amplifier module 82 into a DC current and voltage signal. After being rectified, the induced voltage and current signals can pass through A/D converter module 86. A/D converter module is operable to convert the analog induced voltage and current signals into digital voltage and current signals that can be supplied to HFR module 78.

It should be appreciated that band pass filter module 80, amplifier module 82, rectifier module 84, and A/D converter module 86 can be individual discreet modules or one or more of these modules may be integrated with one another. Furthermore, it should also be appreciated that one or more of these modules may not be needed and may be excluded from signal conditioning module 74. Moreover, it should further be appreciated that one or more of these modules may be integral with HFR module 78 and/or control module 46.

Referring now to FIG. 3B, another exemplary representation of a suitable conditioning module 74 is shown. In this example, signal conditioning module 74 includes a low-pass filter module 88, an A/D converter module 90 and a digital filter module 92. Filter module 88 is operable to allow voltage and current signals below a predetermined frequency to pass therethrough while blocking voltage and current signals above the predetermined frequency. Filter module 88 can prevent the high frequencies caused by the inverters of fuel cell system 20 on the high voltage bus from passing through to A/D converter module 90. Filter module 88 can thereby function as an anti-aliasing filter. The voltage and current signals allowed to pass through filter module 88 may be supplied to A/D converter module 90. Filter module 88 can include analog devices, such as discrete electronic components that may include capacitors, resisters, etc.

A/D converter module 90 can take the filtered voltage and current analog signals and convert them to digital signals that are provided to digital filter module 92. Digital filter module 92 can digitally filter the signals from A/D converter module 90 to extract the induced voltage Vᵢ and induced current Iᵢ caused by test load 58. Digital filter module 92 can utilize software to extract the induced voltage and current signals from the overall stack voltage and current signals. Digital filter module 92 can then supply the induced voltage Vᵢ signal and induced current Iᵢ signal to HFR module 78.

It should be appreciated that low-pass filter module 88, A/D converter module 90 and digital filter module 92 can be individual discreet modules or integrated with one another. Additionally, one or more of these modules may be associated with HFR module 78 or control module 46.

HFR module 78 is operable to calculate the high-frequency resistance or impedance of fuel cells 24 and/or fuel cell stack 22. Specifically, HFR module 78 divides the induced voltage signal Vᵢ by the induced current signal Iᵢ to determine the impedance. The impedance/HFR is related to the SOH of fuel cell stack 22. Optionally, HFR module 78 can include or access one or more look-up tables to ascertain the SOH or a range for the SOH of fuel cell stack 22 based on the calculated impedance. The SOH values in the look-up tables can be based on empirical data and/or modeling of the specific fuel cell stack 22 and/or fuel cell system 20. Additionally, it should be appreciated that use of look-up tables is merely exemplary and that other methods can be applied to derive the membrane humidification level from the HFR value.

Control module 46 can utilize the impedance and/or the associated SOH of fuel cell stack 22 ascertained by HFR module 78 as a diagnostic tool to independently verify the determination of the SOH of fuel cell stack 22 utilizing input from sensors 44. Additionally, control module 46 can utilize the determination of the SOH of fuel cell stack 22 from HFR module 78 to control operation of fuel cell system 20 and implement appropriate adjustments to the components therein to achieve a desired SOH for the given operating conditions in lieu of using the SOH derived with sensors 44.

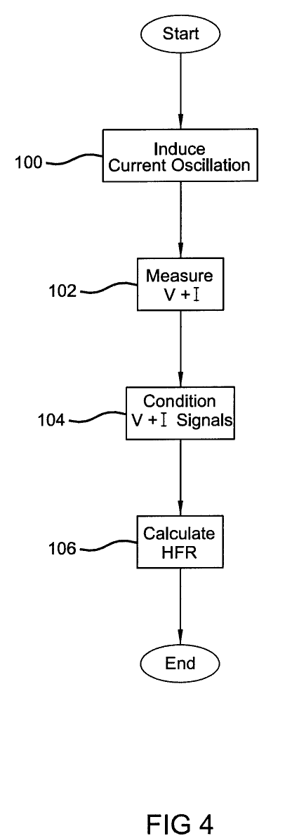

Referring now to FIG. 4, a schematic representation of the determination of the HFR/impedance of fuel cell 24 and/or fuel cell stack 22 is shown. In step 100, control commands test load 58 to be applied across terminals 52a, 52b of fuel cell stack 22 at a particular frequency/frequency range. In step 102, control measures the voltage across fuel cell stack 22 and the current flowing therethrough. In step 104, control conditions the voltage and current signals to extract the AC voltage and AC current induced by test load 58. In step 106, control calculates the HFR/impedance of fuel cell stack 22.

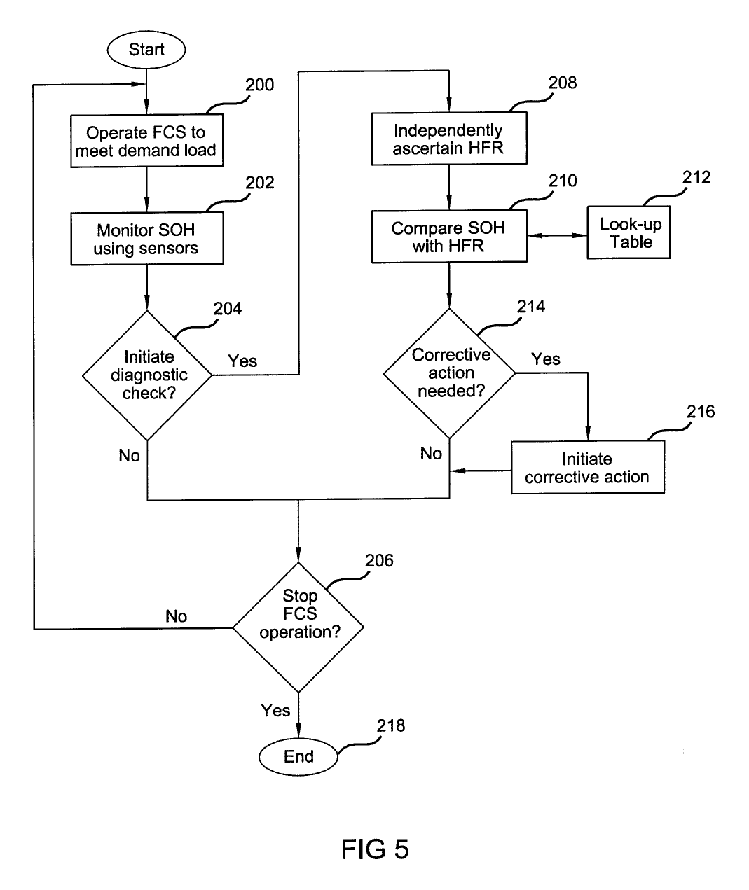

Referring now to FIG. 5, the use of the independent determination of HFR of fuel cell stack 22 as a diagnostic control is shown. Specifically, in step 200, control operates fuel cell stack 22 to meet the demand of load 50. In step 202, control monitors the SOH of fuel cell stack 22 using input from sensors 44. In step 204, control determines if a diagnostic check is to be initiated.

If a diagnostic check is not to be initiated, control moves to step 206. If a diagnostic check is initiated, control moves to step 208. In step 208, control independently ascertains the HFR of fuel cell stack 22. The independent ascertation of the HFR of fuel cell stack 22 is done as described with reference to FIG. 4.

In step 210, control compares the SOH of fuel cell stack 22 ascertained using input from sensors 44 to the HFR determined in step 208. In performing the comparison, control may optionally access a look-up table 212. The look-up table can provide values for the SOH of fuel cell stack 22 as a function of the HFR of fuel cell stack 22 thereby facilitating the comparison of the SOH determined using sensors 44 and the independently ascertained HFR.

In step 214, control determines if corrective action is needed. Corrective action may be required if the SOH of fuel cell stack 22, based on input from sensors 44 and based on the independent ascertation of HFR, differs by a predetermined amount. If no corrective action is necessary, control moves to step 206. If corrective action is required, control moves to step 216 and initiates corrective action. The corrective action can vary based upon the difference between the two independent ascertations of the SOH of fuel cell stack 22. Some types of corrective action can include adjusting of sensors 44, their calibration and/or the calculations based on the output of sensors 44, the signaling of an alarm, and/or a resetting of the model of the SOH of fuel cell stack 22 based on input from sensors 44. After initiating the corrective action, control moves to step 206.

In step 206, control determines if operation of fuel cell stack 22 is to be stopped. If operation of fuel cell stack 22 is not being stopped, control returns to step 200. Control continues to perform steps 200-216, as appropriate, until operation of fuel cell stack 22 is to be ceased. When operation of fuel cell stack 22 ceases, control moves to step 218 and ends.

Thus, the independent ascertation of HFR of fuel cell stack 22 can be used as an independent diagnostic tool to monitor the determination of the SOH of fuel cell stack 22 with data from sensors 44. The ability to independently ascertain the HFR of fuel cell stack 22 can allow corrective action to be initiated to compensate for changes in the operation of fuel cell system 20 and/or to account for drift of sensors 44. Additionally, it should be appreciated that the independent ascertation of HFR of fuel cell stack 22 can also be used to control fuel cell system 20 in the same manner with which the input from sensors 44 are utilized. Thus, the ability to independently ascertain the HFR of fuel cell stack 22 and the associated SOH of fuel cell stack 22 can be advantageously utilized in a fuel cell system 20.

What is claimed is:

1. A method of operating a fuel cell stack in a fuel cell stack system, the method comprising:
inducing a transient load on the fuel cell stack during fuel cell stack operation;
ascertaining a transient voltage output of the fuel cell stack as a result of said transient load;
ascertaining a transient current flow through the fuel cell stack as a result of said transient load; and
calculating an impedance of the fuel cell stack based on said transient voltage output of the fuel cell stack and said transient current flow through the fuel cell stack.

2. The method of claim 1, wherein inducing a transient load includes inducing a transient ohmic load in parallel with the fuel cell stack.

3. The method of claim 1, wherein inducing a transient load includes inducing said transient load at a predetermined frequency.

4. The method of claim 3, wherein inducing said transient load at a predetermined frequency includes inducing said transient load at a predetermined frequency greater than a first frequency below which capacitance of the fuel cell stack appears and less than a second frequency above which inductance of the fuel cell stack appears.

5. The method of claim 1, wherein inducing a transient load includes inducing said transient load on a regular basis during operation of the fuel cell stack.

6. The method of claim 1, wherein ascertaining a transient voltage output and ascertaining a transient current flow include passing said voltage output and current flow through a band pass filter.

7. The method of claim 1, further comprising ascertaining a state of hydration of the fuel cell stack using said calculated impedance.

8. The method of claim 1, further comprising ascertaining an accuracy of an independent determination of a state of hydration of the fuel cell stack based on said calculated impedance.

9. The method of claim 1, wherein ascertaining said transient voltage comprises separating said transient voltage from a DC voltage produced by the fuel cell stack and ascertaining said transient current comprises separating said transient current from a DC current flowing through the fuel cell stack.

10. The method of claim 1, further comprising adjusting operation of the fuel cell stack based on said ascertained impedance.

11. A method of operating a fuel cell stack in a fuel cell system, the method comprising:
operating the fuel cell stack to meet a demand load;
monitoring a state of hydration of the fuel cell stack using a first method; and
initiating a diagnostic check of said first method with a second method that determines a high-frequency resistance of the fuel cell stack.

12. The method of claim 11, wherein said initiating a diagnostic check comprises initiating said diagnostic check on a regular basis during operation of the fuel cell stack.

13. The method of claim 11, wherein said initiating a diagnostic check with said second method comprises:
inducing an AC current through the fuel cell stack; and
inducing an AC voltage across the fuel cell stack.

14. The method of claim 13, wherein inducing said AC current and said AC voltage comprises inducing a transient ohmic load in parallel with the fuel cell stack.

15. The method of claim 13, wherein said second method comprises determining said high-frequency by dividing said induced AC voltage by said induced AC current.

16. The method of claim 15, wherein said second method comprises ascertaining an independent state of hydration of the fuel cell stack using a relationship between said determined high-frequency resistance and the fuel cell stack indicative of a state of hydration of the fuel cell stack.

17. The method of claim 16, wherein initiating said diagnostic check comprises comparing said state of hydration of the fuel cell stack ascertained with said first method to said independent state of hydration of the fuel cell stack ascertained with said second method.

18. The method of claim 17, further comprising initiating a corrective action based on said comparison.

19. A fuel cell system comprising:
a fuel cell stack operable to meet a power demand of a first load;
a second load on said fuel cell stack in parallel with said first load;
a first module operable to selectively apply said second load to said fuel cell stack; and
a second module operable to ascertain a high-frequency resistance of said fuel cell stack based on said first module applying said second load to said fuel cell stack.

20. The fuel cell system of claim 19, further comprising a switch member in series with said second load and wherein said first module drives said switch member to selectively apply said second load on said fuel cell stack.

21. The fuel cell system of claim 20, wherein said first module drives said switch member to generate an AC voltage across said fuel cell stack and an AC current through said fuel cell stack at a predetermined frequency.

22. The fuel cell system of claim 21, further comprising a third module operable to separate said AC voltage and AC current from a DC voltage across said fuel cell stack and a DC current flowing through said fuel cell stack, respectively.

23. The fuel cell system of claim 22, wherein said third module supplies signals indicative of said AC voltage and said AC current to said second module and said second module uses said signals to ascertain said high-frequency resistance.

24. The fuel cell system of claim 23, further comprising a fourth module operable to use said ascertained high-frequency resistance to independently verify a state of hydration of the fuel cell stack.
